(19) United States
(12) Patent Application Publication
(10) Pub. No.: US 2018/0146280 A1
(43) Pub. Date: May 24, 2018

(54) Bone Conduction Speaker with Outer Ear Flap Utilization in Creating Immersive Sound Effects

(71) Applicant: Larry Tang, Pacific Grove, CA (US)

(72) Inventor: Larry Tang, Pacific Grove, CA (US)

(21) Appl. No.: 15/817,577

(22) Filed: Nov. 20, 2017

Related U.S. Application Data
(60) Provisional application No. 62/425,647, filed on Nov. 23, 2016.

(51) Int. Cl. H04R 1/10; H04R 9/06

(52) U.S. Cl. CPC H04R 1/1091; H04R 1/1016; H04R 2460/13; H04R 1/1058; H04R 9/06; H04R 1/105

(57) ABSTRACT

An earbud insertable into a user's ear canal incorporating a bone conduction speaker and a vibrating hook looping around the user's ear for transmitting sound waves impinging upon the user's outer ear flap to the bone conduction speaker.

### CROSS-REFERENCE TO RELATED APPLICATIONS

A Provisional Patent Application covering the invention described herein was filed on Nov. 23, 2016, and assigned Ser. No. 62/425,647.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

### Field of the Invention

This invention relates to bone conduction speakers, in general, and to a manner of improving their sound reproductions, in particular.

### Description of the Related Art

As will be appreciated, normal human hearing works via cooperation of the three parts of the ear anatomy—the outer ear, the middle ear and the inner ear. The outer ear consists of the pinna, ear canal and eardrum, while the middle ear consists of the ossicles (malleus, incus, stapes) and ear drum. The inner ear consists of the distinctively coiled cochlea, on the other hand, the auditory (hearing) nerve and the brain. With hearing, sound waves enter the ear canal and make the ear drum vibrate. This action moves the tiny chain of the ossicle bones in the middle ear—where the last bone in the chain essentially “knocks” on the membrane window of the cochlea and makes the fluid in the cochlea move. Such fluid movement then triggers a response in the hearing nerve (which, when all is working normally, transfer the sound information to the brain).

As is also known and appreciated, the earbud industry as exists today essentially traces back to 2001 when Apple started selling earbuds for use with MP3 players—then becoming a key part of their marketing plan with the introduction of its IPOD music playing system. Now, mobile phones and other portable devices conventionally provide high quality stereo music to enable wearers to listen to music on the go through the use of these earbud head phones.

My U.S. Pat. No. 9,456,282 describes bone conduction speaker units as being particularly beneficial in such earbud headphone use. There, the bone conduction speaker functions on a principle where the speaker typically includes a transducer to receive an electrical signal (such as an audio signal), and to generate a controlled vibration in response. When worn, the transducer transmits the vibration to the bones of the wearer's skull—from which it is transmitted to the wearer's inner ear. The bone conduction then enables sound to be transmitted this way to the wearer's inner ear by vibration, rather than by way of sound waves that travel through the air to enter the wearer's inner ear.

### OBJECT OF THE INVENTION

While acknowledging the advantages that follow the employment of bone conduction speaker units in general, and those of my above patent in particular, in these earbud housings, it is an object of the present invention to modify their constructions in a manner to improve sound reproduction even more so, as in the providing of a spatial effect to sound reproduction analogous to that of 3D viewing effects introduced to the visual perception of movie and television productions.

### BRIEF DESCRIPTION OF THE INVENTION

As a starting point to the invention is the understanding that binaural recording systems are unique because they emulate the workings of the human head. The architecture of the anatomy dictates how sounds heard are understood; with an ear on either side of a thick skull and spongy brain, sounds which enter the left and right ears are heard at different times. If, for example, a dog barks by the left ear, it takes a few extra microseconds for the bark to reach the right ear (the sound also appearing to be louder in the left ear than in the right). At the same time, sound waves interact with the physical constitution of the listener—the pinna (or outer ear), the head, and the torso —, as well as with the surrounding space, both in creating listener-specific variations commonly known as head-related transfer functions. The brain scrutinizes such minuscule inter-aural differences of time and strength in order to localize sound with immaculate precision.

In accordance with the present invention, a more realistic 3D audio response is provided to fully immerse users of bone conduction speaker earbuds through the use of a vibration transmitter means which couples the outer ear flap to the bone conduction speaker in producing the sound signal to the middle ear for interpretation by the brain. By constructing the vibration transmitter as cooperating with the bone conduction speaker and held in place by the ear, substantially the complete realm of external sound is able to travel through the entire cartilage system of the ear structure to the inner ear. The end result is a totally different listening experience which produces the truly representative 3D sound as interpreted by the brain.

### BRIEF DESCRIPTION OF THE DRAWINGS

These and other features of the invention will be more clearly understood from a consideration of the following description, taken in connection with the accompanying Drawings, in which:

FIGS. 1A-1D represent directional views of a right-side earbud embodying the invention as employed in an earbud which utilizes a regular moving coil speaker in addition to a bone conduction speaker (directional views of a left-side earbud being mirror images); and

FIGS. 2 and 3 represent cross-sectional views of the earbud helpful in an understanding of its construction.

### DETAILED DESCRIPTION OF THE INVENTION

As understood, the human ear is very sensitive to hearing via the inner ear—where previously not very much recognition of the purpose of the ear flap in hearing has been given, especially when it comes to using an earbud in listening to music. Although the understanding is well known as to how sound can travel by means of a soft bone of a bone conduction speaker to the middle ear in producing a signal of sound to be interpreted by the brain, the present invention proceeds on the recognition that the outer ear flap is similarly made up of cartilage and soft bone. As will be discussed below, the invention utilizes a special hook, termed a vibration transmitter (or a similarly operational configuration)—placed adjacent to the bone conduction speaker unit in sending to the inner ear directly through the ear structure, the sound signal picked up at the ear flap.

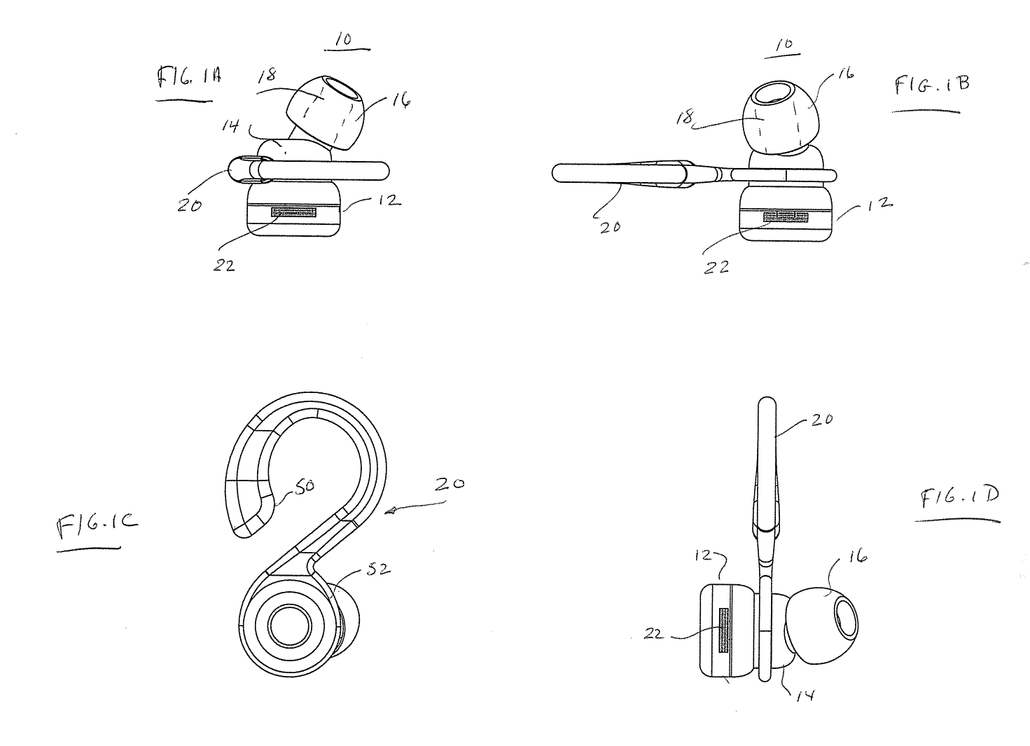

FIGS. 1A-1D illustrate an earbud constructed in accordance with the invention 10, as employing a bone conduction speaker compartment 12, an additional moving coil speaker compartment 14, an ear tip 16 preferably of silicone with a stem inside 18, and a vibration transmitting hook 20, (not necessarily scaled to size in the drawings, nor proportionally correct in FIG. 1C, but for purposes of illustration and understanding). Reference numeral 22 then identifies the opening in the earbud 10 for the electrical wire connection to the mobile phone or other portable music device (FIGS. 1A, 1B, and 1D).

Understanding that a left side earbud representation in accordance with the invention would appear as a mirror image to the views of FIGS. 1A-1D, the moving coil speaker compartment 14 is located closer to the ear tip 16, and the bone conduction speaker compartment 12 is placed to the rear, further from the ear tip 16. The vibration transmitter hook 20 (shown in place in FIGS. 1A and 1B) serves to send the sound waves impinging on the ear flap in transmitting them along to the bone conduction speaker in compartment 12. As understood from FIGS. 1C and 1D, the shape of the upper end 50 of the transmitter hook 20 is designed to loop from the front of the ear first, being pushed backwards so as to snugly press on the back of the lobe—preferably, placed to touch the back of the earlobe in providing optimal operation as contrasted if it were only placed in grazing contact with it. Also noting that the hook 20 may face in the opposite direction than as shown in FIGS. 1C and 1D, in having the hook placed on the ear from the back side first, then looped to the front—with either arrangement, the lower end 52 of the hook 20 loops around the moving coil speaker compartment 14 adjacent the bone conduction speaker compartment 12. While the hook 20 can be made of metal or hard plastic, it has been found preferable to be made with a soft and pliable plastic like polyurethane, so that the shape of the hook can be adjusted to conform to different shapes of the ear as is common from one person to the next. The upper end 50 of the hook 20 in this respect is designed to be longer than an ordinary hook of the kind used for ornamental purposes that is not normally utilized to transmit sound signal vibrations so that in implementation, it is preferable to rest on the top skin of the back side of the lobe, to have a slight tension making a soft and pliable plastic fabrication preferable.

In like manner, the vibration transmitting function providing the spatial sound reproduction effect can still be performed if the hook is facing in the other direction, but such a configuration is not as desirable. At the same time, having the upper end of the loop at 50 slightly thicker and angled to touch on the corresponding skin with more efficiency is an improvement as well, as a slightly thicker end will make better optimization of the sound signal transmitted from the earlobe. In an alternate configuration, the hook transmitter could be manufactured with its lower end 52 in hard plastic or metal, and with upper end 50 continuing in soft plastic material double molded to the lower end. The purpose of such a configuration will be appreciated by those skilled in the art to allow the lower end piece 52 to be set with ornamental pieces in cosmetic utilization as gems, stones, or like appurtenances.

As a further modification, the earbud-vibration transmitter hook unit providing the spatial sound reproduction effect could be provided with a cover or “muff”, as to appear similar to the increasingly popular over-the-ear phones—but with the advantage of offering the immersive 3D bi-aural quality.

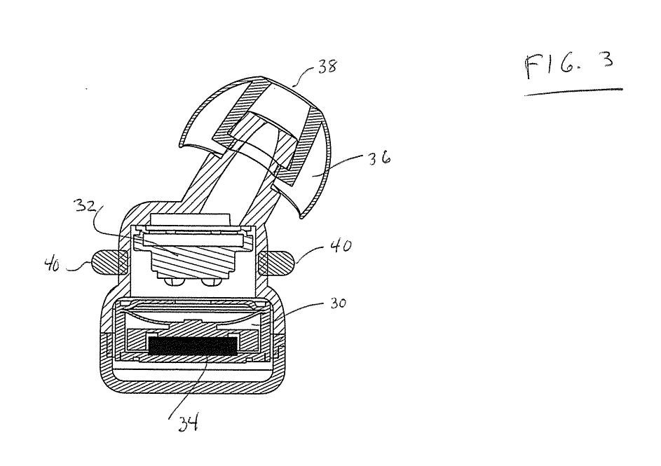

FIG. 3 illustrates a cross-section view of the earbud of the invention with the bone conduction speaker shown at 30, the moving coil speaker shown at 32, the opening for electrical wire connecting at 34 and the ear tip, ear stem components shown at 36, 38 respectively. In the manufacture of the earbud, a hollow body is formed, defining a first compartment in which the bone conduction speaker is fitted, with the hollow continuing upwardly although reduced in diameter in forming a second smaller compartment in which the moving coil speaker is placed. A pair of wires are then welded in a parallel arrangement to the bone conduction speaker unit, and then further electrical wires are welded to pass through the opening 34 in the middle of the bone conduction speaker. A sound screen of the moving coil speaker unit faces upwardly in continuing into the earbud stem 38. The vibrating transmitter hook shown at 40 loops on the compartment 32 where the moving coil speaker sits in providing the sound signal to the inner ear. As will be appreciated this allows the sound of the moving coil speaker in this preferred embodiment to continue through to the ear canal via the compressed air caused by the sound signal from the moving coil speaker itself.

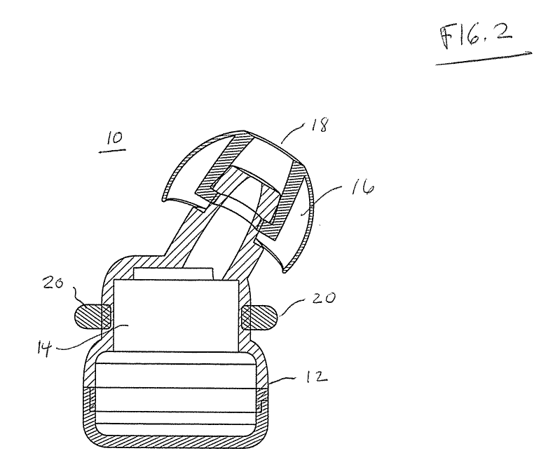

But, the sound signal from the bone conduction speaker at 30 does not travel through this route as it employs “vibration” to transmit and deliver the sound signal—via the ear tip vibration all the way through the stem 38, via the walls of the bone conduction speaker unit which sits in the middle of the pinna, and via the transmitter hook 40 all the way to the pinna itself. Optimum operation results by having the upper end of the transmitter hook touching the back side of the earlobe although enhanced performance results even when just having it very close to the front side of the earlobe, if not in actual physical contact with it. And, as will be appreciated by the skilled artisan, the improvement in sound can be achieved even without the employment of a moving coil speaker in the earbud, as the described configuration permits all the sound waves from the outer ear flap to reach the inner ear as well. This is illustrated by FIG. 2 where the bone conduction speaker is fitted into the hollow compartment 42 and where the second, smaller compartment 44 is devoid of the moving coil speaker.

While there have been described what are considered to be preferred embodiments of the invention, it will be readily appreciated by those skilled in the art that modifications can be made without departing from the description and teachings herein. For at least such reason, therefore, resort should be had to the following claims for a clear understanding of the scope of the invention.

We claim:

1. In an earbud insertable into a user's ear canal, the combination of a bone conduction speaker, and vibration means coupled therewith for transmitting vibrations to said bone conduction speaker as received from sound waves impinging upon the user's outer ear flap when said vibration means are worn thereat.

2. The combination of claim 1 wherein said vibration means is configured for looping around the ear of the user.

3. The combination of claim 2 wherein said vibration means is configured in the form of a hook.

4. The combination of claim 1, also including a moving coil speaker coupled between said bone conduction speaker and an ear tip output of said earbud.

5. The combination of claim 4 wherein said vibration means is configured in the form of a hook having a first end configured to loop over the user's outer ear flap at one end, and coupled to said moving coil speaker overlying said bone conduction speaker on an opposite second end of said hook.

6. The combination of claim 2 wherein a first end of said vibration means is configured to snugly press upon the back of the user's ear lobe.

7. The combination of claim 5 wherein said first end of said hook is configured to snugly press upon the back of the user's earlobe, and said opposite second end of said hook is coupled to said moving coil speaker.

8. The combination of claim 6 wherein said first end of said vibration means is fabricated of a soft, pliable composition.

9. The combination of claim 8 wherein said second end of said vibration means is fabricated of one of a hard plastic or metal.

10. The combination of claim 7 wherein said first end of said hook is fabricated of a soft, pliable composition.

11. The combination of claim 10 wherein said second end of said hook is fabricated of one of a hard plastic or metal.
